(19) United States
(12) Patent Application Publication
(10) Pub. No.: US 2009/0305052 A1
(43) Pub. Date: Dec. 10, 2009

(54) Stable Aqueous Graphite Dispersion With High Solids Content

(75) Inventor: Werner Handl, Altdorf (DE)

Correspondence Address: RANKIN, HILL & CLARK LLP, 23755 Lorain Road - Suite 200, North Olmsted, OH, 44070-2224, US

(73) Assignee: GRAPHIT KROPFMUHL AG, Hauzenberg (DE)

(21) Appl. No.: 12/066,387

(22) PCT Filed: Sep. 8, 2006
(86) PCT No.: PCT/DE06/01572

§ 371 Date: Dec. 8, 2008

(30) Foreign Application Priority Data
Sep. 13, 2005 (DE) 10 2005 043 542.4

(51) Int. Cl. C09D 1/00; C10M 169/04; C10M 111/04; C10M 103/00; B32B 17/06; B32B 13/04; H01B 1/24

(52) U.S. Cl. 428/426; 106/286.8; 508/113; 508/116; 508/130; 508/128; 508/125; 508/129; 428/446; 252/511

(57) ABSTRACT

The invention relates to an aqueous graphite dispersion including graphite particles dispersed in water along with stabilizers acting as dispersants, and additives. The graphite particles are at least partially spherical.

The present invention concerns an aqueous graphite dispersion comprising graphite particles, stabilisers, additives and water, wherein the graphite particles are dispersed in the water and the stabilisers are provided as dispersants, a process for preparing the aqueous graphite dispersion and its use.

A dispersion is understood to be a system consisting of a plurality of phases, of which one phase is continuous (dispersant) and at least one further phase is finely divided (disperse phase or discontinuous phase). Since dispersions have a tendency towards phase separation, various auxiliary agents such as emulsifiers, protective colloids and dispersing aids are used for stabilisation purposes.

In an aqueous graphite dispersion, graphite, which is finely divided in the dispersant water, is used as the discontinuous phase.

Graphite dispersions are adequately described in the literature and have a broad range of applications.

For instance, graphite dispersions are used as lubricants and/or release agents in hot metal forming. It is a requirement of such graphite dispersions that they adhere to both cold and hot metal surfaces and form a lubricating and protective film. The purpose of this is not only to make the metal easier to form but also to reduce tool wear during forming. Graphite dispersions are also used as a coating, for example for the interior coating of battery compartments or for rubber vulcanisates, e.g. for windscreen wipers, but also as a conductive coating on plastics, glass, ceramics, etc.

In addition to being non-toxic and stable in storage, aqueous graphite dispersions are required above all to offer all-round processability. For instance, depending on the application, such dispersions are applied predominantly by spraying, for example. The viscosity of the aqueous dispersion plays an important part in this. Particularly low-viscosity dispersions with a high solids content are preferred.

Particularly when used in high concentrations, aqueous graphite dispersions should have a stable viscosity flow even at high shear rates. Dilatant, rheopectic and/or thixotropic formations are therefore undesirable. A stable viscosity flow is only possible if the particles in the disperse phase are able to slip past one another unimpeded at any shear rate.

The dispersion solutions can be sprayed using the classic compressed air method (airspraying) and without compressed air (airless). Transfer using rollers, brushes, etc. is also in use. For all these methods, dispersions are required which in addition to being suitable for the particular application system also produce a perfect finish on the coated surface. The criteria for this are as follows:

a) smooth, streak-free finish
b) no cratering (orange peel effect)
c) no dripping
d) perfect flow
e) good adhesion

Graphite dispersions without auxiliary substances are extremely highly viscous and in some cases thixotropic. This is due to the platelet-like structure of the graphite particles, which form a “house of cards” structure in liquids. This house of cards structure is also known from other platelet-like substances, such as clay minerals or kaolins, for example. In this case, however, the use of peptisers can cause this house of cards structure to collapse and the stability can be increased by using electrostatically active substances. Such mechanisms of action with peptisers do not work with graphite.

According to the prior art, macromolecular substances are also used to stabilise graphite dispersions. Such macromolecular substances from the compound groups of mono- and polysaccharides act as protective colloids here, increasing the viscosity. Polyelectrolytes such as sodiμm carboxymethyl cellulose, alginates or salts of lignosulfonic acids come under the known spectrum of activity.

Where protective colloids are used according to the prior art, the problem of crushing of molecule chains occurs if they are added prior to grinding. It is known that cellulose derivatives, for example, are broken down into shorter molecule chains under high shear stress.

It is known that graphite particles have no zeta potential. It is therefore largely immaterial whether wetting and/or dispersants belonging to the anionic, cationic, non-ionogenic or amphoteric family are used. Their activity is therefore based solely on lowering the surface tension of the liquid and wetting the surface of the graphite particles. Dispersions based on surface-active substances tend towards rapid sedimentation. Owing to the platelet-like structure of the graphite, the sediments are then very dense and difficult to redisperse.

The determining factors in disperse systems are the size of the exchange surface and the thickness of the boundary layers. The specific phase boundary is hyperbolically dependent on the particle diameter. Very fine-particle dispersions with a particle diameter of <1.0 μm therefore have a greater tendency to form agglomerates, so the theoretical stability advantage deriving from Stokes' Law is increased by the formation of large particles. Agglomerates sediment at a comparable rate to primary particles of the same size.

Owing to the platelet shape of the graphites used according to the prior art, elaborate dispersion methods have to be used even at the preparation stage. These are energy-intensive ball mills or attrition mills, rotor-stator stirring devices or ultrasonic stirrers.

Sedimentation of the platelet-like graphite particles leads to a deposit that is extremely difficult to redisperse. This is due to the fact that the platelet-like particles are deposited horizontally and form stack-like entities. The surface-to-surface pairing leads to what is known as a glass plate effect and the particles bond together with high adhesive force.

Numerous methods and formulations have been proposed for preparing aqueous dispersions:

For instance, U.S. Pat. No. 5,800,739 concerns an aqueous dispersion consisting of graphite particles, wherein a polymer stabiliser having repeating alkylene oxide groups with a hydrophile-lipophile balance (HLB) in excess of 10 is used as the stabiliser. The graphite content lies in a range from 0.5 to around 10 wt. % of the dispersion.

U.S. Pat. No. 5,476,580 describes a graphite dispersion comprising 0.1 to 20 wt. % graphite with an average particle size in the range from 0.05 to 50 μm and optionally dispersants and surfactants. A galvanisation process using the aqueous graphite dispersion is also described.

U.S. Pat. No. 4,401,579 discloses a lubricant composition which is suitable for forging processes. This composition can optionally contain graphite in an amount from around 3 to 30 wt. %.

US 2001001096 concerns a high-temperature lubricant dispersion containing between around 10.0 and 30 wt. % of suspended graphite. The method of preparing this lubricant dispersion is also described.

The disadvantage of the known dispersions lies in the fact that despite the use of active additives, maximum solids contents of only 30 wt. % are obtainable. In addition, the rheological characteristics of the dispersions are not ideal. This disadvantage is particularly significant during use, since all-round application is not possible. For example, dispersions are expected to be able to be used with all commercial spraying devices, roller application or knife systems, in other words they have to be stable across a broad shear range. The surface quality of the coating is ultimately dependent on this.

A further substantial disadvantage is the sedimentation. Ultimately all substances tend to sediment sooner or later, depending on the particle size, but the manner in which deposits or sediments can be restored to a stable dispersion is absolutely critical.

The object of the present invention is to provide a stable aqueous dispersion of graphite particles which has high dispersion stability, a low viscosity combined with a high solids content, and is easy to redisperse.

This is achieved according to the invention by an aqueous graphite dispersion with graphite particles, stabilisers, additives and water, wherein the graphite particles are dispersed in the water and the stabilisers are provided as dispersants, wherein the surface of the graphite particles is at least partially spherical.

At least partially spherical means any geometry of graphite particles which can be associated with a spherical form. This includes graphite particles with a spherical surface.

However, it also includes graphite particles whose surface is approximately spherical. Graphite particles with an approximately spherical surface are understood to be graphite particles for which the radius of a graphite particle is not identical at all points. In other words these are graphic particles having an irregular spherical form.

Also included are elliptical, oval, plum-shaped and dumbbell-shaped graphite particles and the like, as well as mixed forms of the above. It is particularly preferable if the surface of the graphite particles is approximately spherical. It is most particularly preferable if the surface of the graphite particles is spherical.

Thus the graphite particles can be present in a mixed form comprising 60 to 99 wt. % of graphite particles having a spherical surface and 1 to 40 wt. % of graphite particles having an at least partially spherical surface. It is preferable if the graphite particles are present in a mixed form comprising 80 to 99 wt. % of graphite particles having a spherical surface and 1 to 20 wt. % of graphite particles having an at least partially spherical surface. It is most preferable if the graphite particles are in a mixed form comprising 90 to 99 wt. % of graphite particles having a spherical surface and 1 to 10 wt. % of graphite particles having an at least partially spherical surface.

Using known grinding methods, the surface of the graphite particles can be treated by folding and compression in such a way that graphite particles are obtained whose surface is at least partially spherical.

These methods use rotor mills or hammer mills, for example, with a special grinding track geometry. However, rotor-stator systems with a special nip design can also be used. Such systems correspond to the prior art and are available for example from Hosokawa Alpine or Nara Machinery.

When these graphite particles are dispersed in water, a type of dense packing of spheres is obtained, as a result of which a minimum of dispersion water is needed. Owing to the at least partially spherical form of the graphite particles, the dispersion has surprising rheological properties. As already mentioned above, dilatant, rheopectic and/or thixotropic formations are undesirable. Particles in the disperse phase are therefore required to be able to slip past one another unimpeded at any shear rate. Graphite particles whose surface is at least partially spherical are able to slip past one another in this way. In addition, the thixotropic properties that exist in the case of platelet-like graphite particles do not occur.

The graphite particles have an average particle size (d50) of 0.05 to 100 μm. It is particularly preferable if the graphite particles have an average particle diameter (d50) of 1 to 50 μm and an average particle size (d50) of 2 to 20 μm is most particularly preferred.

The viscosity of the aqueous graphite dispersion according to the invention lies in a range from 500 to 6000 mPa s. A range from 1000 to 3000 mPa s is particularly preferred and the range from 1000 to 2000 mPa s is most particularly preferred.

Stabilisers which are selected from at least one compound of the group consisting of dispersing aids, wetting agents and protective colloids are used to stabilise the graphite dispersion.

Macromolecular compounds are preferred, particularly those selected from the group consisting of polyethylene glycols, mono- and polysaccharides such as alginates, cellulose derivatives, xanthans, starch derivatives, polyelectrolytes, salts of lignosulfonic acids, polyvinyl alcohols, polyvinyl pyrrolidones and polyacrylates.

In addition, further additives can be added, as required and depending on the intended purpose. These include preservatives such as formaldehyde, formaldehyde derivatives and isothiazolinones. Furthermore, additives can be used which are selected from the group consisting of molybdenum disulfide, boron nitride, tungsten disulfide, sodium borates, sodium silicates, sodium molybdates, bentonites and montmorillonites.

Molybdenum disulfide, boron nitride and tungsten disulfide act as lubricants here. The other cited additives can also be used inter alia as bonding agents.

An aqueous graphite dispersion according to the invention contains

10 wt. % to 70 wt. % of graphite particles,
0.5 wt. % to 3 wt. % of stabilisers,
0 wt. % to 4 wt. % of additives,
based in each case on the total weight of the graphite dispersion, the remainder being water.

It is preferable if the graphite particles make up 30 wt. % to 60 wt. %, based on the total weight of the graphite dispersion. A solids content of graphite particles of 45 wt. % to 55 wt. % is most particularly preferred. According to the current prior art, graphite dispersions with a solids content of more than 30 wt. % no longer demonstrate Newtonian flow.

The ease with which deposits can be redispersed has proved to be a further advantage. This is explained by the fact that the particles exhibit only localised contact and the adhesive “glass plate effect” does not arise. In addition, in the intermeshing zones that are always present there is sufficient space for the highly active macromolecular stabilisers. As well as lowering the surface tension, these stabilisers are also intended to act as spacers. Spacer molecules are understood to be macromolecular compounds which accumulate at the surface of particles and prevent their steric approach.

A further object of the invention is to provide a process for preparing an aqueous graphite dispersion according to the invention.

This object is achieved by dissolving the stabilisers in water one after another whilst stirring in a first step and adding the graphite particles whilst stirring in a second step.

It is particularly important to follow this sequence since otherwise inadequate graphite dispersions are obtained.

A particular advantage of the process according to the invention for preparing the graphite dispersion lies in the fact that the use of graphite particles according to the invention requires only simple vane stirrers or propeller stirrers.

There is therefore no need to use elaborate ball mills, attrition mills, rotor-stator stirring devices or ultrasonic stirrers.

A bypass stirrer can also be used for the dust-free incorporation of the graphite powder. Here the powder is drawn into the water below its surface, and this also allows a considerable reduction in the mixing time.

The invention also concerns the use of the aqueous graphite dispersion as a lubricant and/or release agent in hot metal forming and as a coating for interior coating or for rubber vulcanisates or as a conductive coating on plastics, glass and ceramics.

With regard to features of the invention not mentioned in any detail above, reference is made expressly also to the claims.

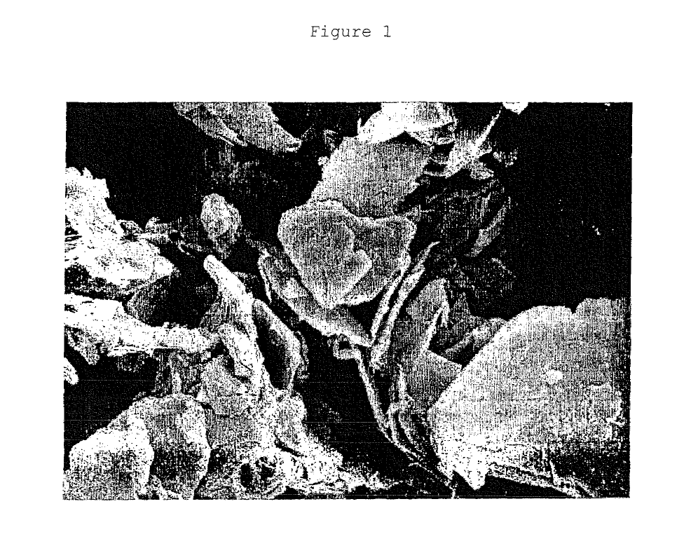

FIG. 1 shows a scanning electron microscopic image of platelet-like graphite of the prior art.

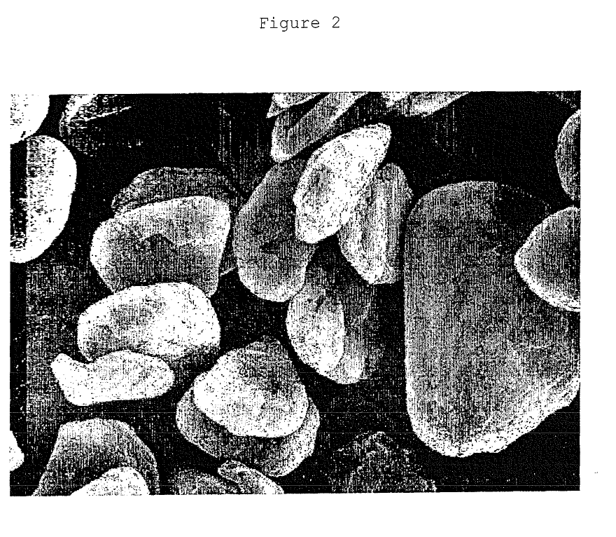

FIG. 2 shows a scanning electron microscopic image of graphite particles according to the invention.

The invention is explained in more detail below by reference to the examples, which do not limit the invention.

### EXAMPLE 1

50.00 kg of demineralised water are placed in a container having a vane stirrer and 1.00 kg of polyethylene glycol having a molecular weight of 1500 (non-ionogenic wetting agent) are dissolved whilst stirring. Then 1.50 kg of sodium carboxymethyl cellulose having a degree of substitution of 0.8 to 1.2 (protective colloid) are then dissolved, likewise whilst stirring. Whilst continuing to stir, 47.5 kg of graphite particles are then added, the surface of which is at least partially spherical and which have an average particle size (d50) of 10 μm. The entire process is completed after 30 minutes. Larger batches, for example 1000 kg, can be prepared in the same time in a comparable manner. The dispersion has a viscosity of 1290 mPa s and is resistant to sedimentation for 90 days. The sediments formed after this time were able to be stirred and redispersed without difficulty.

### EXAMPLE 2

In the same way as in Example 1, 0.5 kg of naphthalene sulfonic acid, the condensation product of sodium salt (anionic wetting agent), are dissolved in 55.00 kg of demineralised water and then 0.5 kg of xanthan (protective colloid based on polysaccharide β-1,4 with glycosidic crosslinking) are dissolved. Then 3.5 kg of sodium silicate and 40.5 kg of graphite particles whose surface is at least partially spherical and which have an average particle size (d50) of 8.5 μm are stirred in. The dispersion has a viscosity of 1950 mPa s and is resistant to sedimentation for 90 days. The sediments formed after this time were able to be stirred and redispersed without difficulty.

1. An aqueous graphite dispersion comprising graphite particles, stabilizers, additives and water, wherein the graphite particles are dispersed in the water and the stabilizers function as dispersants, wherein the surface of the graphite particles is at least partially spherical.

2. The aqueous graphite dispersion of claim 1, wherein the surface of the graphite particles is spherical.

3. The aqueous graphite dispersion of claim 1, wherein the graphite particles include 60 to 99 wt. % of graphite particles having a spherical surface and 1 to 40 wt. % of graphite particles having an at least partially spherical surface.

4. The aqueous graphite dispersion of claim 3, wherein the graphite particles include 80 to 99 wt. % of graphite particles having a spherical surface and 1 to 20 wt. % of graphite particles having an at least partially spherical surface.

5. The aqueous graphite dispersion of claim 3, wherein the graphite particles include 90 to 99 wt. % of graphite particles having a spherical surface and 1 to 10 wt. % of graphite particles having an at least partially spherical surface.

6. The aqueous graphite dispersion of claim 1, wherein the graphite particles have an average particle size (d50) of 0.05 to 100 pm.

7. The aqueous graphite dispersion of claim 1, wherein the dispersion has a viscosity in the range from 500 to 6000 mPa s.

8. The aqueous graphite dispersion of claim 1, wherein the stabilisers are selected from the group consisting of dispersing aids, wetting agents and protective colloids.

9. The aqueous graphite dispersion of claim 8, wherein the stabilisers are selected from the group consisting of polyethylene glycols, monosaccharides, polysaccharides, alginates, cellulose derivatives, xanthans, starch derivatives, polyelectrolytes, salts of lignosulfonic acids, polyvinyl alcohols, polyvinyl pyrrolidones and polyacrylates.

10. The aqueous graphite dispersion of claim 1, wherein the additives are selected from the group consisting of preservatives, molybdenum disulfide, boron nitride, tungsten disulfide, sodium borates, sodium silicates, sodium molybdates, bentonites and montmorillonites.

11. The aqueous graphite dispersion of claim 1, wherein the aqueous graphite dispersion includes 10 wt. % to 70 wt. % of graphite particles, 0.5 wt. % to 3 wt. % of stabilisers, and 0 wt. % to 4 wt. % of additives; based in each case on the total weight of the graphite dispersion, the remainder being water.

12. The aqueous graphite dispersion of claim 11, wherein the aqueous graphite dispersion includes 30 wt. % to 60 wt. % of graphite particles, 0.5 wt. % to 3 wt. % of stabilisers, and 0 wt. % to 4 wt. % of additives, based in each case on the total weight of the graphite dispersion, the remainder being water.

13. A process for preparing the aqueous graphite dispersion of claim 1 comprising dissolving the stabilizers in water one after another under stirring and adding the graphite particles under stirring.

14. The process of claim 13, wherein stirring is effected with a vane stirrer or propeller stirrer.

15. The process of claim 13, wherein stirring is effected with a bypass stirrer is used as the stirrer.

16. A process of hot metal forming including adhering to the surface of a metal article the aqueous graphite dispersion of claim 1 and heating the metal article.

17. An article of manufacture comprising a substrate selected from the group consisting of plastics, glass and ceramics, together with a conductive coating comprising the aqueous dispersion of claim 1.

18. A rubber vulcanizate including a coating comprising the graphite dispersion of claim 1.

19. The aqueous graphite dispersion of claim 2, wherein the graphite particles include 60 to 99 wt. % of graphite particles having a spherical surface and 1 to 40 wt. % of graphite particles having an at least partially spherical surface.

20. The aqueous graphite dispersion of claim 19, wherein the graphite particles include 80 to 99 wt. % of graphite particles having a spherical surface and 1 to 20 wt. % of graphite particles having an at least partially spherical surface.
